(19) United States
(12) Patent Application Publication
(10) Pub. No.: US 2026/0078783 A1
(43) Pub. Date: Mar. 19, 2026

(54) POSITION CONTROLLER

(71) Applicant: Samson Aktiengesellschaft, Frankfurt am Main (DE)

(72) Inventors: Fausto Crespo Vidal, Lagenselbold (DE); Sven Rausch, Nidderau (DE)

(73) Assignee: Samson Aktiengesellschaft, Frankfurt am Main (DE)

(21) Appl. No.: 19/109,054

(22) PCT Filed: Sep. 4, 2023
(86) PCT No.: PCT/EP2023/074179

§ 371 Date: Mar. 5, 2025

(30) Foreign Application Priority Data
Sep. 6, 2022 (DE) 10 2022 122 576.3

(51) Int. Cl. F15B 21/08; F16K 31/42

(52) U.S. Cl. CPC F15B 21/08; F16K 31/42

(57) ABSTRACT

A positioner for a pneumatic actuator for actuating a control instrument, such as a control valve, of a process plant, may include an electropneumatic converter, such as a current-pressure converter; a circuit board which carries supply electronics for the electropneumatic converter a casing which comprises at least one electronics compartment in which at least one electronic component of the positioner, in particular the supply electronics, is accommodated, and a converter compartment, in which the electropneumatic converter is accommodated. The electronics compartment and the converter compartment may be spatially separated from one another. The converter compartment may be delimited at least partially by the circuit board.

### CROSS REFERENCE TO RELATED APPLICATIONS

This patent application is a United States national stage application of International Application No. PCT/EP2023/074179, filed Sep. 4, 2023, which claims priority to German Patent Application No. 10 2022 122 576.3, filed Sep. 6, 2022, each of which is incorporated herein by reference in its entirety.

### BACKGROUND

The disclosure relates to a positioner for a pneumatic actuator for actuating a control instrument, such as a control valve, of a process plant.

Field device for a process plant having a casing for the pressure-resistant encapsulation of electrical components for an environment with an explosive or flammable atmosphere is known, for example, from DE 10 2020 122 321 A1. An electropneumatic positioner can be accommodated in a compartment of the casing. A pneumatic supply line for actuating a pneumatic actuator is guided through the electropneumatic converter of the positioner through a pneumatic opening in the outer wall of the casing. In order to connect the positioner to a compressed air source and/or sink, the outer wall of the casing can be provided with secured pneumatic openings.

EP 0 587 170 B1 describes an electropneumatic signal converter which is to be of modular construction and explosion-proof. A current-pressure converter is arranged in a hollow casing section which has a pneumatic supply connection and a pneumatic output for controlling an actuator. The casing also comprises a box section with electrical contacts accommodated therein. Electrical, pneumatic and electropneumatic components are accommodated in the casing. The casing has an electronics casing module for the electrical components and a pressure casing module, which can be screwed therein, for the pneumatic and electropneumatic components. The electronics casing module is separated from the pressure casing module by a module wall through which conductors are guided in an explosion-proof manner for contacting the electropneumatic components. A pressure sensor is also arranged in the electronics compartment.

In the case of improper use of electropneumatic positioners, there is a risk that dirt introduced into the casing chamber can lead to deposits on the positioner electronics and electropneumatics. Dirt deposits can lead to damage or malfunctions, for example as a result of short circuits of electrical contacts. It has been found that the introduction of dirt, for example in the case of damage or contamination of the pneumatic pressure supply, or the use of a pneumatic pressure supply of lower quality is to be expected.

If an explosive and/or flammable gas, for example natural gas, is to be used as a pneumatic medium, there is also the requirement that leakage of the combustible gas at the positioner is not permitted. The combustible pneumatic medium has to be discharged through a collection pipe. Such combustible gases can also have a corrosive effect and lead to damage to electronic components. It is also conceivable that ignition can occur as a result of electrical currents.

### BRIEF DESCRIPTION OF THE DRAWINGS/FIGURES

The accompanying drawings illustrate the embodiments of the present disclosure and, together with the description, further serve to explain the principles of the embodiments and to enable a person skilled in the pertinent art to make and use the embodiments.

FIG. 1 shows a cross-sectional view of an exemplary embodiment of a positioner according to the disclosure.

FIG. 2 shows a cross-sectional view of an exemplary embodiment of a positioner according to the disclosure, with a potting encasing the circuit board.

FIG. 3 shows another cross-sectional view of the positioner according to FIG. 2.

FIG. 4 shows a plan view of the interior space of the positioner according to FIG. 2.

FIG. 5 shows a plan view of the interior space of the positioner according to FIG. 4 without support body and circuit board.

FIG. 6 shows a perspective detail view of a support plate from a first direction, according to an exemplary embodiment.

FIG. 7 shows a perspective detail view of the support plate according to FIG. 6 from a second direction.

FIG. 8 shows a sectional view through the support plate with circuit board fastened thereto, according to an exemplary embodiment.

FIG. 9 shows a perspective detail view of the circuit board according to an exemplary embodiment.

FIG. 10 shows a detailed view of a cover part for covering a venting channel from the electronics compartment through the casing of a positioner, according to an exemplary embodiment.

FIG. 11 shows a sectional view through the cover part with through-holes and the venting channel according to FIG. 10.

FIG. 12 shows a detailed view of the cover part according to an exemplary embodiment.

FIG. 13 shows a view of the casing of the positioner according to FIG. 10 from below.

FIG. 14 shows a detailed view of an alternative cover part with groove ducts according to an exemplary embodiment.

FIG. 15 shows a cross-sectional view of the positioner according to FIG. 10.

FIG. 16 shows a schematic illustration of a positioner according to an exemplary embodiment.

The exemplary embodiments of the present disclosure will be described with reference to the accompanying drawings. Elements, features and components that are identical, functionally identical and have the same effect are-insofar as is not stated otherwise-respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

An object of the disclosure is to provide a positioner which overcomes the disadvantages of the prior art, in particular is suitable for the use of a critical pneumatic medium, such as a corrosive, dirty, explosive and/or flammable pneumatic medium.

Accordingly, a positioner is provided for a pneumatic actuator for actuating a control instrument, such as a control valve, of a process plant, in particular a petrochemical plant, of a power plant, of a food processing plant, in particular a brewery, or the like. The positioner comprises an electropneumatic converter, a circuit board and a casing.

In particular, the electropneumatic converter can be implemented as a current-pressure converter. An electropneumatic converter implements an electropneumatic component of a positioner. An electropneumatic converter may be designed and configured to set a converter pressure as a function of an electrical signal. In an exemplary embodiment, an electropneumatic converter is designed and configured to set the converter pressure starting from, on the one hand, a pneumatic source, which provides a pressurized pneumatic medium, such as room air, nitrogen or the like, at a supply pressure, and, on the other hand, a pneumatic sink, such as the atmosphere, which defines a reference pressure, for example corresponding to the ambient pressure. In an exemplary embodiment, an electropneumatic converter is configured to set the converter pressure based on an electrical signal, in particular an analog or digital electrical signal, such as a current signal or a voltage signal. For example, the electropneumatic converter can be implemented as a current-pressure converter and, in particular, set the converter pressure proportionally or at least substantially proportionally to a current signal. The electropneumatic converter may be designed and configured to provide the converter pressure for at least one other pneumatic component, such as a pneumatic amplifier, at an active input or active output. In an exemplary embodiment, a pneumatic component denotes a purely pneumatically or mechanically-pneumatically acting component, in particular free of electronics. In other words, it is clear that, within the scope of the present disclosure, a distinction can be made between, on the one hand, pure pneumatic components and, on the other hand, pure electronic components and furthermore electropneumatic hybrid components. For operation with a combustible pneumatic medium, in particular natural gas, the at least one electronic component, the at least one electropneumatic converter and/or the optional at least one pneumatic sensor can be operated intrinsically safely. In an exemplary embodiment, an electropneumatic converter provides a converter pressure with a very low volumetric flow rate.

The circuit board carries supply electronics for the electropneumatic converter. Optionally, the circuit board can carry open-loop and/or closed-loop control electronics for actuating the electropneumatic converter. Alternatively, it is conceivable that the open-loop and/or closed-loop control electronics for the electropneumatic converter are divided into a plurality of electronic components, in particular circuit boards of the positioner, such as comprising the circuit board. Circuit board can generally denote a planar component made of an electrically insulating material, such as a fiber-reinforced plastic material, a ceramic material, hard paper or the like, to which electrical and/or electronic components are fastened. Circuit boards can usually be embodied as so-called circuit boards. In particular, the circuit board has conductor tracks on at least one surface, such as on two mutually opposite surfaces. The conductor tracks may be fixedly attached, for example printed or soldered, to the at least one surface of the circuit board. Additionally, or alternatively, the circuit board can be equipped with feedthroughs in order to electrically connect conductor tracks on a first surface, for example the upper side, to conductor tracks on a second surface, for example the lower side. Electrical and/or electronic components, such as microchips, microprocessors, resistors, capacitors, diodes, contacts, plug connections or the like, can be fastened, for example adhesively bonded, clamped, screwed and/or soldered, to at least one surface of the circuit board, such as with electrical contacting of conductor tracks. A circuit board generally has a planar shape, wherein the planar outline can be embodied in a manner adapted to the casing accommodating the circuit board, for example in a semicircular manner. The circuit board may have a width dimension and a length dimension which substantially have the same order of magnitude or the dimensions of which differ from one another by not more than a hundred times, in particular not more than a ten times. The circuit board has a thickness dimension which is substantially smaller than the width dimension and the length dimension of the circuit board, wherein the dimensions thereof are smaller, for example, by at least ten times, in particular by at least the hundred times. Feedthroughs or the like extend through the circuit board in the thickness dimension.

The casing has at least one electronics compartment in which at least one electronic component of the positioner, in particular supply electronics, is accommodated. Furthermore, the casing has at least one converter compartment in which the electropneumatic converter is accommodated. The electronics compartment and the converter compartment may be spatially separated from one another. In particular, the electronics compartment and the converter compartment are separated from one another pneumatically and/or in a pressure-resistant manner. A pressure-resistant region or pressure-resistant compartment of the positioner can be designed and configured, for example, in a pressure-resistant manner for an environment with an explosive or flammable atmosphere. For example, different regions in the casing can be separated from one another in order to meet the explosion protection requirements “Ex d”, that is to say the ignition protection type of the pressure-resistant encapsulation “Ex d”. The design according to the disclosure makes it possible to implement a particularly simple, cost-effectively producible, compact and reliable positioner. The casing may surround an interior space. The casing may be designed in such a way that the interior space is designed as a pressure-encapsulated space. The subdivision of the interior space into an electronics compartment and a converter compartment separated therefrom makes it possible to avoid corrosion and/or contamination on electronic components, in particular on the circuit board. The casing may surround the converter compartment and the electronics compartment. The casing may include or consist of at least two shell parts connected releasably to one another. The shell parts forming the casing can be implemented, for example, as a pot-shaped main body with at least one opening and a releasable cover which completely closes the opening in an operational assembly state. The casing can be designed and configured for dust-and/or water-protected accommodation of electrical, electronic, electropneumatic, pneumatic and other components. The casing can be designed, for example, in accordance with the protection type IP65 or better. A casing for dust-and/or water-protected accommodation of electrical components can be defined, for example, in accordance with a protection type of the so-called International Protection Code (IP Code). Protection types can describe the degree of protection of the casing against contact, foreign bodies, water and the like. IP codes can be stipulated, for example, in accordance with IEC 529, EN 60529, DIN VDE 0470-1 in the version applicable in 2014 in each case. The first digit of the IP code denotes the protection against foreign bodies and contact, wherein a higher value determines a more pronounced protection. The first digit can have the following meaning: 3: protected against solid foreign bodies of greater than 2.5 mm and against contact with tool; 4: protected against solid foreign bodies of greater than 1 mm and against contact with wire; 5: protected against dust and contact; 6: sealed against dust, protected against contact. The second digit of the IP code relates to the protection against water. The second digit can have the following meaning: 3: protected against spray water; 4: protected against spray water; 5: protected against jet water; 6: protected against strong jet water or heavy sea; 7: protected against temporary submersion; 8: protected against permanent submersion. The casing can correspond, for example, at least to the protection type IP 65, at least IP 66, at least IP 67, at least IP 68 or at least IP 69.

According to the first aspect of the disclosure, it is provided that the converter compartment is delimited at least partially by the circuit board. It is clear that the boundary of the converter compartment is intended to be implemented by the circuit board in an operational assembly state of the positioner. In an operational assembly state of the positioner, a pressure-proof separation into, on the one hand, the converter compartment and, on the other hand, the electronics compartment can be implemented by the circuit board. The circuit board can implement a complete boundary of the converter compartment alone or in combination with one or more further components of the positioner, such as a support plate and/or at least one sealing element. The use of the circuit board of the positioner in functional union for carrying at least one electronic component and for delimiting the converter compartment makes it possible to reduce the number of components in a positioner and also the assembly complexity, wherein the positioner can be embodied in a manner particularly suitable for use with corrosive or other critical pneumatic media by the skillful arrangement of the circuit board.

In an embodiment of a positioner according to the first aspect of the disclosure, the electropneumatic converter is arranged on a side of the circuit board facing away from the electronics compartment. In particular, the circuit board carries the electropneumatic converter. Alternatively, or additionally, a support body, which may be fastened to the circuit board and carries the electropneumatic converter, can be provided. The circuit board can be fastened to the casing of the positioner by means of the circuit board and/or the support body. The electropneumatic converter can be arranged, in particular fastened or fastenable, for example pluggable, on the converter-compartment-side of the circuit board. In an exemplary embodiment, the at least one electronic component, in particular the supply electronics, and optionally the open-loop and/or closed-loop control electronics, is or are arranged on a first, in particular upper, side of the circuit board, and that the electropneumatic converter is arranged on a second, in particular lower, side of the circuit board facing away from the first side. The circuit board can have a side, which is in particular equipped or can be equipped with few, insensitive and/or protected components, for arrangement in the converter compartment, and a side opposite thereto which is oriented so as to be protected from critical pneumatic medium (facing away from the converter compartment).

In another embodiment of a positioner according to the first aspect of the disclosure, which can be combined with the above, the converter compartment is formed by at least one receptacle which is arranged in a wall portion of the casing and/or is formed integrally with the casing, wherein the receptacle is at least partially covered by the circuit board. In an exemplary embodiment, the electropneumatic converter is arranged or can be arranged at least partially or completely in this receptacle. The converter compartment can be formed by a plurality of receptacles which are arranged in a wall portion of the casing and/or are formed integrally with the casing and are at least partially covered by the circuit board. A plurality of receptacles forming the converter compartment can be spatially separated from one another by intermediate walls, and optionally pneumatically and/or in a pressure-resistant manner. In a casing with a converter compartment which is composed of a plurality of receptacles, a first receptacle can be designed and configured as a converter receptacle and can accommodate the electropneumatic converter, and at least one second receptacle or further receptacles can accommodate further electropneumatic components, for example at least one pneumatic sensor. With the aid of pneumatic and/or pressure-proof insulation of the converter compartment which can be filled with critical pneumatic medium, contamination or damage to the electronics components arranged in the electronics compartment can be avoided. For operation with a combustible pneumatic medium, in particular natural gas, the at least one electronic component, the at least one electropneumatic converter and/or the optional at least one pneumatic sensor can be operated intrinsically safely.

In a development of the positioner, at least one sealing element, such as a sealing ring, is arranged between the circuit board and a casing region surrounding the receptacle, in order to separate the converter compartment from the electronics compartment, in particular in a pressure-proof and/or pneumatic manner. In an exemplary embodiment, a pressure-proof separation can be designed and configured for a pressure difference between, on the one hand, the converter compartment and, on the other hand, in the electronics compartment, or the converter receptacle, on the one hand, and the electronics compartment and/or other receptacles, on the other hand, of at least 50 mbar, in particular at least 100 bar, preferably at least 1 bar, particularly preferably at least 1 bar, and/or not more than 10 bar, in particular not more than 5 bar, preferably not more than 2.5 bar. The at least one sealing element can be arranged in sealing touch contact with the circuit board and/or the casing. It is clear that the at least one sealing element can be arranged, in particular in an operational assembly state, in the positioner for fluidic insulation of the converter compartment.

In an alternative or additional development of the positioner, the circuit board has, in the region of the converter compartment, in particular in the region of the at least one receptacle, such as a locally delimited, surface coating for protection against pneumatic medium. The surface coating can have a thickness in the range from 1 μm to 1 mm, preferably in the range from 10 μm to 300 μm. The surface coating can comprise or consist of a plastic material. The plastic material of the surface coating may be particularly corrosion-resistant to the pneumatic medium provided in operation. In addition, an encapsulation can optionally be provided which at least partially surrounds the circuit board and which forms a boundary, at least in portions, of a chamber and/or receptacle. A surface coating can comprise or consist of, for example, a lacquer.

According to an exemplary embodiment, at least one pneumatic sensor is arranged in the converter compartment. A pneumatic sensor can be, for example, a pressure sensor, a temperature sensor, an air humidity sensor or the like, or a combination of a plurality or all of the said sensors. The circuit board may carry the at least one pneumatic sensor. In this case, the electronic component, in particular the supply electronics and optionally the open-loop and/or closed-loop control electronics, may be arranged on a first, in particular upper, side of the circuit board, and the pneumatic sensor is or are arranged on a second, in particular lower, side facing away from the first side. In an exemplary embodiment, the at least one pneumatic sensor is arranged or can be arranged on the same side of the circuit board as the electropneumatic converter. In particular, the converter compartment comprises at least one receptacle in which at least one pneumatic sensor is arranged. This receptacle can also be referred to as a sensor receptacle. The converter compartment can have, in particular, a plurality of receptacles for a multiplicity of pneumatic sensors. For example, the positioner in the converter compartment can comprise a converter receptacle and a plurality of sensor receptacles which are separated from one another pneumatically and/or in a pressure-resistant manner. It is clear that, alternatively or additionally, at least one pneumatic sensor can be arranged in the receptacle for the electropneumatic converter. This at least one receptacle can be formed, for example, by an indentation of the casing or the like. In an exemplary embodiment, different measuring points may be provided in the positioner, and at least one of the plurality of different pneumatic sensors is assigned to each of the different measuring points. According to an exemplary embodiment, the positioner in the converter compartment comprises a plurality of, in particular further, receptacles with different pneumatic sensors arranged therein, in order to detect different pressures in the positioner, for example a pressure of the pneumatic medium at an input and/or output of the electropneumatic converter, a pressure of the pneumatic medium at a supply input of the positioner, which supply input is connected to a pneumatic source, and/or a pressure of the pneumatic medium at a positioning output of the positioner for actuating a pneumatic actuator. In an exemplary embodiment, the different receptacles form individually pressure-encapsulated spaces in the interior of the casing. Individual pressure-encapsulated spaces are pressure-proof in relation to one another. The subregion which is assigned to the converter compartment, and which accommodates the electropneumatic converter forms a first individually pressure-encapsulated space. A plurality of individual subregions which are assigned to the converter compartment and which each accommodate at least one or precisely one pneumatic sensor form a plurality of second individually pressure-encapsulated spaces. An exchange of pneumatic medium into and/or out of a pressure-encapsulated space is possible in the operating state exclusively by means of a specific number of predetermined pneumatic lines, such as precisely one pneumatic line, precisely two pneumatic lines or precisely three pneumatic lines. In an exemplary embodiment, the first pressure-encapsulated space is equipped by means of precisely two pneumatic lines, namely the ventilation line and an exhaust air duct. In an exemplary embodiment, the second pressure-encapsulated spaces each have only precisely one single pneumatic line. The electronics compartment can realize a further individually pressure-encapsulated space, wherein the electronics compartment can be equipped free of one or with precisely one pneumatic line, in particular embodied as a venting line. Optionally, the pneumatics compartment can form an additional individually pressure-encapsulated space. The number of pneumatic lines with which the pneumatics compartment is equipped can correspond to the sum of the pneumatic lines of the first and of the second pressure-encapsulated space.

According to a second aspect of the disclosure, a positioner is provided which comprises an electropneumatic converter, a circuit board with supply electronics, and a casing which has a converter compartment and an electronics compartment separated therefrom. The first and the second aspect of the disclosure can be combined with one another.

According to the second aspect of the disclosure, it is provided that the converter compartment has an exhaust air duct for discharging pneumatic medium from the electropneumatic converter to a collection pipe for exhaust air and/or for discharging pneumatic medium into a pneumatic compartment. According to the second aspect of the disclosure, the positioner can have a pneumatic compartment in which at least one pneumatic component, such as a pneumatic amplifier, a pressure reducer or a flow restrictor, is accommodated. The casing may have the pneumatic compartment in addition to the converter compartment and the electronics compartment. For example, the casing can have an interior space which is divided or can be divided into electronics compartment and converter compartment and separated from the interior space by a circumferential wall, a wall portion or the like, the pneumatic compartment. The pneumatic compartment can be implemented, for example, by a side space which has an opening which can be closed completely by a cover. In an exemplary embodiment, a pneumatic component denotes a purely pneumatically or mechanically-pneumatically acting component, in particular free of electronics. In other words, it is clear that, within the scope of the present disclosure, a distinction can be made between, on the one hand, pure pneumatic components and, on the other hand, pure electronic components and furthermore electropneumatic hybrid components. With the aid of the exhaust air duct and/or the collection pipe, critical pneumatic medium can be discharged from the converter compartment while bypassing electronic components, such as all electronic components. In an exemplary embodiment, the exhaust air of the positioner, in particular of the electropneumatic converter thereof, is discharged at a distance from sensitive components, in particular electronic components, of the electronic unit. The exhaust air of the electropneumatic converter may be trapped in a separate exhaust air chamber which is sealed off from the electronics compartment. The exhaust air duct supports the pressure encapsulation of, on the one hand, the electropneumatic converter accommodated in the converter compartment or a subregion thereof and, on the other hand, of the electronics compartment. The subregion which is assigned to the converter compartment and which accommodates the electropneumatic converter forms a first individually pressure-encapsulated space from which exhaust air escapes only in a controlled manner through the exhaust air duct. The electronics compartment can realize a further individually pressure-encapsulated space, with the result that it can advantageously be ensured that the electronic components in the electronics compartment are protected from contaminated exhaust air.

According to a development of the second aspect of the disclosure, an ignition lock, in particular a sinter filter, is arranged in or on the at least one exhaust air duct and/or the at least one collection pipe. The cross section of the collection pipe and/or the exhaust air duct may be covered over the full area with the ignition lock at least along a duct section. Such an embodiment can be advantageous, in particular, for use of the positioner with a flammable or explosive-endangered pneumatic fluid and/or in a flammable and/or explosive-endangered environment, in order to delimit locally the consequences of a possible sparking or the like at the electropneumatic converter.

According to a third aspect of the disclosure, a positioner is provided which comprises an electropneumatic converter, a circuit board with supply electronics, and a casing which has a converter compartment and an electronics compartment separated therefrom. The third aspect of the disclosure can be combined with the first and/or second aspect of the disclosure.

According to the third aspect of the disclosure, a pneumatic compartment is provided in which at least one pneumatic component, such as a pneumatic amplifier, a pressure reducer or a flow restrictor, is accommodated. The casing may have the pneumatic compartment in addition to the converter compartment and the electronics compartment. For example, the casing can have an interior space which is divided or can be divided into electronics compartment and converter compartment and separated from the interior space by a circumferential wall, a wall portion or the like, the pneumatic compartment. The pneumatic compartment can be implemented, for example, by a side space which has an opening which can be closed completely by a cover. In the third aspect of the disclosure, it is furthermore provided that the electronics compartment may be spatially separated from the converter compartment and also from the pneumatic compartment. It is clear that the separation of the pneumatic compartment in relation to the electronics compartment and the converter compartment relates to an operational assembly state of the positioner according to the disclosure. The subdivision into converter compartment, electronics compartment and pneumatic compartment can be implemented, for example, by barriers, such as separating walls, which can be inserted into the casing and/or are formed integrally with the casing. The subdivision into converter compartment, electronics compartment and pneumatic compartment can optionally be implemented by a multi-part casing, wherein, in a preassembly state, one or more of the compartments can be arranged with one another in different parts of the casing which can be assembled or undivided within a part of the casing, and wherein, in an operational assembly state, the compartments are present separately from one another. Alternatively or additionally, it can be provided that, in the preassembly state, at least one casing part is provided which is provided undivided or with a division, for example a separating wall, for forming two of the three aforementioned compartments, for example the electronics compartment and the converter compartment, wherein, in the operational assembly state, the third compartment, for example the pneumatic compartment, is provided by at least one further casing module which can be connected in particular to the casing. In particular, the converter compartment and the pneumatic compartment are separated from one another pneumatically and/or in a pressure-resistant manner. Optionally, the electronics compartment is separated from the converter compartment pneumatically and/or in a pressure-resistant manner. In particular, the electronics compartment is pneumatically insulated from the converter compartment and optionally the pneumatic compartment.

In a development of the positioner according to the third aspect of the disclosure, at least one pneumatic line is provided which connects the converter compartment, in particular the at least one receptacle, such as the converter receptacle or a sensor receptacle, to the pneumatic compartment. A pneumatic line which issues from the converter compartment can be realized, for example, by a collection pipe and/or an exhaust air duct as described above with respect to the second aspect of the disclosure. The casing may have a wall portion which may at least partially delimit the converter compartment, and at least one pneumatic line extends through this wall portion and/or base. It is conceivable that two or more, in particular mutually separate, pneumatic lines lead from the converter compartment to the pneumatic compartment. For example, the converter compartment can be equipped with an exhaust air duct in order to discharge exhaust air of the electropneumatic converter and with a pneumatic line implemented as a supply air duct. In addition, individual sensor compartments could each be assigned at least one pneumatic line for fluidic communication with a respective measuring point in the region of the pneumatic compartment.

According to an exemplary embodiment, at least one ignition lock, in particular a sinter filter, is arranged in the at least one pneumatic line. In particular, at least one ignition lock is arranged in at least one pneumatic line between the pneumatic compartment and the electropneumatic converter. Alternatively, or additionally, an ignition lock is arranged in at least one pneumatic line between the pneumatic compartment and the at least one pneumatic sensor. In an exemplary embodiment, the plurality of pneumatic lines are in particular all equipped with at least one respective ignition lock, in particular a sinter filter. By virtue of the fact that the electropneumatic components, such as the electropneumatic converter and optionally pneumatic sensors, may be arranged individually in chambers of the converter compartment and are connected by means of respective pneumatic lines to other pneumatic and/or electropneumatic components or the surroundings which are covered with an ignition lock, the risk of damage as a result of malfunctions of the individual electropneumatic components can be minimized.

In an exemplary embodiment of the positioner according to the third aspect of the disclosure, the casing has a casing portion which at least partially forms, in particular surrounds, the pneumatic compartment and which comprises a pneumatic interface for connecting the at least one pneumatic component, such as a plurality of pneumatic components, such as all pneumatic components of the positioner, wherein this pneumatic interface is in fluidic connection with the converter compartment. The pneumatic component or pneumatic components is or may be contained in a pneumatic module, in particular a common and/or component-uniform pneumatic module. By integrating one or a plurality of pneumatic components into a single common pneumatic module, the design and the assembly of the positioner can be embodied in a particularly simple manner. Such a modular configuration of the positioner without major conversions over different assembly states of small components is a major advantage.

In an embodiment of a positioner according to the first, second and/or third aspect of the disclosure, the circuit board is encased by an encapsulation, in particular a potting. Alternatively, or additionally, the supply electronics are encased by an encapsulation, in particular a potting. In addition, the encapsulation can encase optional open-loop and/or closed-loop control electronics. In particular, the encapsulation may form a pressure-proof pneumatic sealing element for separating the electronics compartment from the converter compartment. Alternatively, or additionally, the encapsulation may seal the circuit board and/or the supply electronics with respect to the electronics compartment or at least substantially seals them. The circuit board can be sealed or at least substantially sealed with respect to the electronics compartment by the encapsulation at least in portions in at least one region or a plurality of regions, where at least one electronics component and/or electrical conductor track is fastened to the circuit board. In an exemplary embodiment, all electronics components and/or electrical conductor tracks on the electronics compartment-side surface of the circuit board may be coated with the at least one encapsulation. In particular for use with an explosive and/or flammable gas, for example natural gas, as a pneumatic fluid, the circuit board and optionally the supporting body can be completely potted, in particular within the casing, wherein only at least one plug for electrical contacting of the at least one electronic component, such as the supply electronics, and/or a small region of the circuit board in the surroundings of the contacts for the electropneumatic converter and/or the at least one pneumatic sensor remains or remain free.

According to a particular embodiment of a positioner according to the first, second and/or third aspect of the disclosure, the electronics compartment has a venting line for compensating a pressure difference, in particular an overpressure or a negative pressure, with respect to the surroundings of the positioner. In particular, the venting line is arranged remote from the converter compartment, in particular the receptacles thereof, i.e. the converter receptacle and the optional plurality of sensor receptacles. The electronics compartment may be designed pneumatically and/or in a pressure-resistant manner, separated from the converter compartment and optionally the pneumatic compartment, that is to say does not communicate fluidically with the other compartment(s). The electronics compartment can be closed or ventilated or vented via the venting line, in particular independently of an optionally attached pneumatic module, the photovoltaic chamber or the operating medium. In the case of an airtightly closed electronics compartment, there would be the possibility of a differential pressure with respect to the atmosphere being set as a result of temperature differences with respect to the surroundings. In the case of such a design, there is the risk that, for example as a result of an unexpectedly occurring thunderstorm or the like, a previously sun-lit casing cools down abruptly. In this case, a negative pressure in relation to the surroundings would be generated within the closed compartment, which negative pressure could draw in rainwater from the surroundings through gaps. Ventilation or venting of the electronics compartment via the venting line is able to effectively prevent this effect.

In a development of the positioner with venting channel, the venting line has a muzzle which may be completely covered by an in particular detachable cover part. Alternatively or additionally, an ignition lock, in particular a sinter filter, is arranged in the venting line. In an exemplary embodiment, the ignition lock is arranged in front of the cover part. The ignition lock may cover the venting line between the cover part arranged at the muzzle and the electronics compartment. The cover part can be embodied in a movable manner. The casing of the positioner and the cover part may be matched to one another in such a way that the cover part can be mounted in at least one first and at least one second predetermined cover position. The cover part and the casing can be equipped with at least one positioning aid for fixing predetermined positions, for example, the casing can have a projection and the cover part can have an opening or recess which is complementary to the projection. The cover part can be positionable at the muzzle in a first cover position, in which the cover part closes the electronics compartment, such as airtightly. The cover part can be positionable at the muzzle in a second cover position, in which the venting line is designed to be open to the surroundings by the cover part. The cover part can have at least one ventilation region in which, for example, a through-bore or a groove channel is arranged, through which the muzzle communicates fluidically with the surroundings. The cover part can be designed at least regionally as a closure part for sealing closure of the venting line.

According to an alternative embodiment of a positioner according to the first, second and/or third aspect of the disclosure, a ventilation duct connects the electronics compartment fluidically to the converter compartment. The ventilation of the electronics compartment, in particular for avoiding negative pressure, can in this case take place through the ventilation duct to the converter compartment. Such an embodiment can be expedient, for example, when using the positioner with a non-critical pneumatic fluid, such as ambient air. The positioner may be implemented in combination with a circuit board without encapsulation. A ventilation duct can be arranged, for example, in a contact region of the circuit board and of the casing and/or in a contact region of the circuit board and of the support body. In an exemplary embodiment, the region of the ventilation duct is embodied free of sealing elements.

According to a development, the ventilation duct is implemented by at least one opening, such as a groove, in a sealing seat on the circuit board, the support body or the casing, wherein the sealing seat is designed and configured for accommodating a sealing element, such as a sealing ring. In this development, the sealing seat is not covered with the insertable sealing element. For example, a ventilation duct can be implemented on the circumferential edge of an annular groove receptacle for a sealing ring which can be inserted between support body and circuit board, with this sealing ring being omitted.

In a further exemplary development of the positioner with venting channel, the venting line has a muzzle which may be completely covered by an in particular detachable cover part. A membrane can be arranged between the muzzle and the cover part. In this case, the membrane can be designed in such a way that it is actively active in particular exclusively in the open position of the cover part or plate. The membrane acts as a pressure compensation element. Configurations with a pressure compensation element designed differently from a membrane are also conceivable. The membrane or the pressure compensation element can be attached, such as adhesively bonded, to the casing, an inner wall or to the cover part or can be clamped between the cover part and the casing, in particular directly or via a sealing element. Alternatively, the cover part can be arranged in front of the muzzle in such a way that a section of the cover part which is free of passage openings, groove ducts and the like covers the venting channel. A sealing element surrounding the muzzle in an annular manner can be arranged between the cover part and the outer wall. The membrane can be implemented in one piece with the sealing element as a pressure compensation element with an adhesively bonded round sealing ring (for example as a standard part). In the closed position of the cover part, the venting line can be closed or sealed off with the aid of the sealing element. In a state in which the cover part covers the muzzle for closure of the electronics compartment, it is alternatively conceivable for the membrane or a pressure compensation element to be omitted or not mounted. The sealing element can be placed releasably against the membrane and/or the muzzle, wherein in particular the electronics compartment can be connected flexibly to or separated from the surroundings. It is conceivable that the casing forms a storage region, in particular in the form of a recess, in which the sealing element can be stored in a state separated from the membrane and/or the muzzle. In an exemplary embodiment, the storage region is covered by the cover part in a state of the cover part fastened to the casing. In an exemplary embodiment, the sealing element is held in the storage region via the cover part in a state of the cover part fastened to the casing and, in particular when the state of the cover part changes, can be removed from the storage region, for example for assembly on the membrane or the muzzle, such as for separating the electronics compartment from the surroundings.

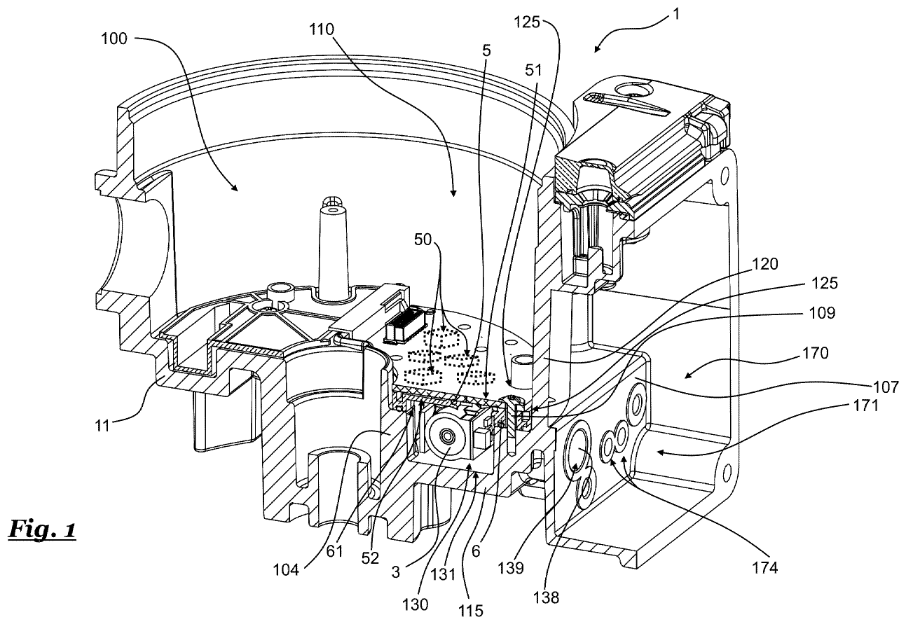

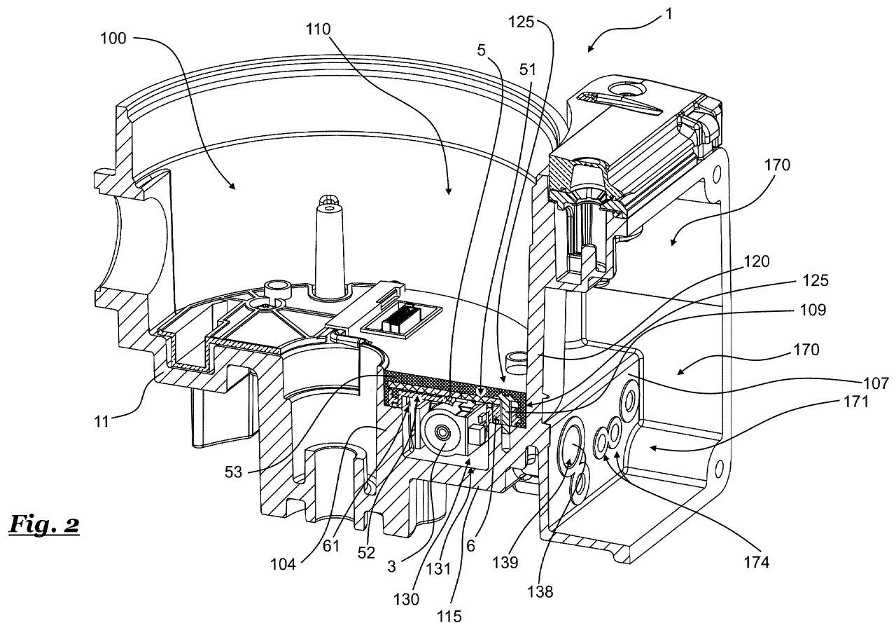

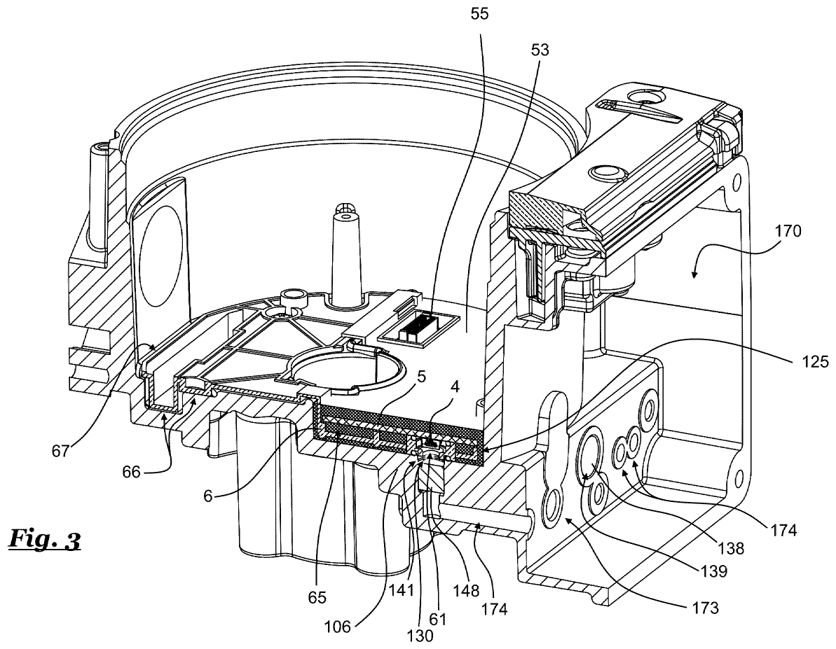

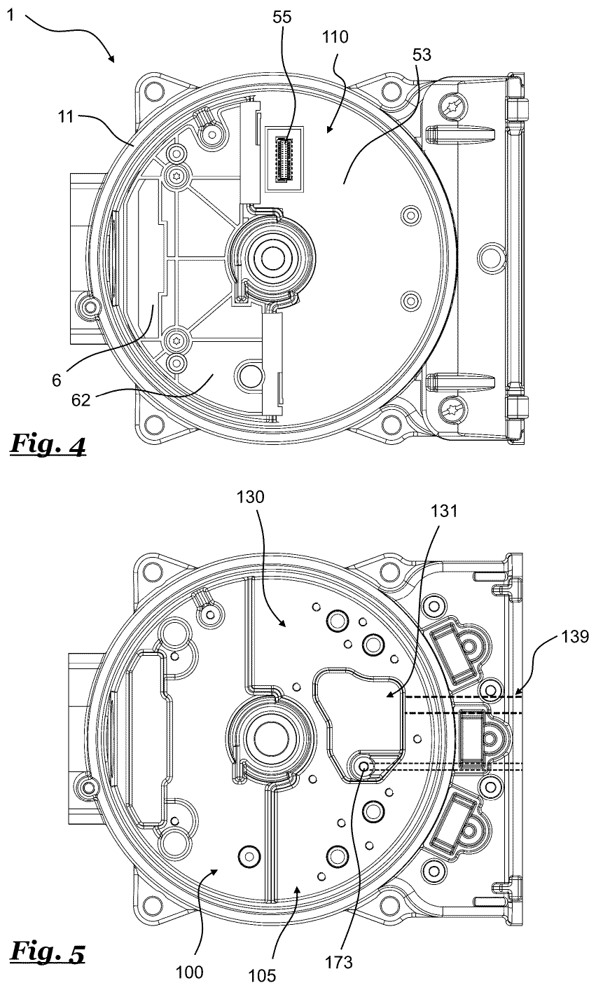

A positioner according to the disclosure is generally provided with the reference symbol 1. A first embodiment of a positioner 1 is illustrated in FIG. 1 and another embodiment of a positioner 1 with a potting 53 is illustrated in FIG. 2.

The positioner 1 shown in FIG. 1 comprises, as essential components, an electropneumatic converter 3, which can be referred to below by way of example as a current-pressure converter, and a circuit board 5, which can be referred to below by way of example as a circuit board. The circuit board 5 is substantially flat. For insertion into a cylindrical casing 11, the circuit board 5 can have a partially annular or partially circular cross section.

The circuit board 5 is equipped with electrical conductor tracks (not illustrated in detail) and at least one electronics component, which can also be referred to as an electronic component. Electronics components which implement the supply electronics 50 are arranged on the circuit board 5. Other electronics components comprise, for example, a plug connector 55 for electrically and/or signal-transmitting connecting of the supply electronics 50 circuit board 5, for example, to a supply unit, a superordinate control unit or the like of the positioner 1 (not illustrated in detail). The electropneumatic converter 3 is connected to the circuit board 5. The electropneumatic converter 3 can be fixedly connected, for example by soldering, to the circuit board 5. Alternatively, the electropneumatic converter 3 can be equipped with a plug and the circuit board 5 can be equipped with a corresponding socket or plug receptacle 57. The circuit board 5 is also equipped with supply electronics (not illustrated in more detail) for the electropneumatic converter 3. Furthermore, the circuit board can be equipped with open-loop and/or closed-loop control electronics, or parts thereof, for actuating the electropneumatic converter 3. In the exemplary embodiments described below, the circuit board 5 is also equipped with one or more electropneumatic components or hybrid components.

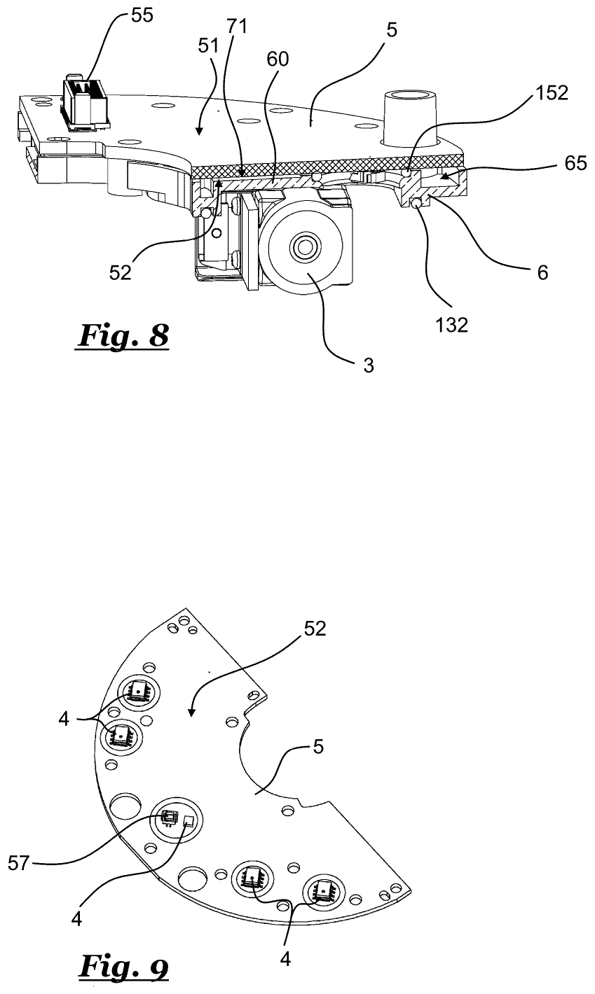

The positioner 1 comprises a casing 11. The casing surrounds an interior space 100. The circuit board 5 and the electropneumatic converter 3 are arranged within the casing 11. The circuit board 5 is expediently arranged within the casing 11 in such a way that it separates into, on the one hand, an electronics compartment 110 in which at least one electronic component of the positioner 1 is arranged and, on the other hand, a converter compartment 130 in which the electropneumatic converter 3 is accommodated. The circuit board 5 may be one-piece planar body with an upper side 51 and a lower side 52. Starting from the upper side 51, the electronics compartment 110 expands and, starting from the lower side 52, the converter compartment 130 expands. The electronics component is arranged on the upper side 51. The electropneumatic converter 3 is arranged on the lower side 52, as shown by way of example in FIGS. 7 and 8. On the lower side 52, in addition to next to the electropneumatic converter 3, for example four pneumatic sensors 4 can be arranged (FIG. 9).

The circuit board 5 is accommodated in an operational assembly arrangement of the positioner 1 in the interior space 100 thereof. In the operational assembly state of the positioner 1, the interior space 100 is divided into the electronics compartment 110 and the converter compartment 130. The circuit board 5 is fixedly connected, for example screwed, to the casing 11. FIG. 2 shows the fastening of the circuit board 5 to the casing 11 by means of a fastening screw 109 which holds the circuit board 5 on the base 115 of the casing 11 delimiting the interior space 100. On the base 115 of the casing 10, a depression 105 is recessed which is complementary to the circuit board 5 and into which the circuit board 5 is inserted.

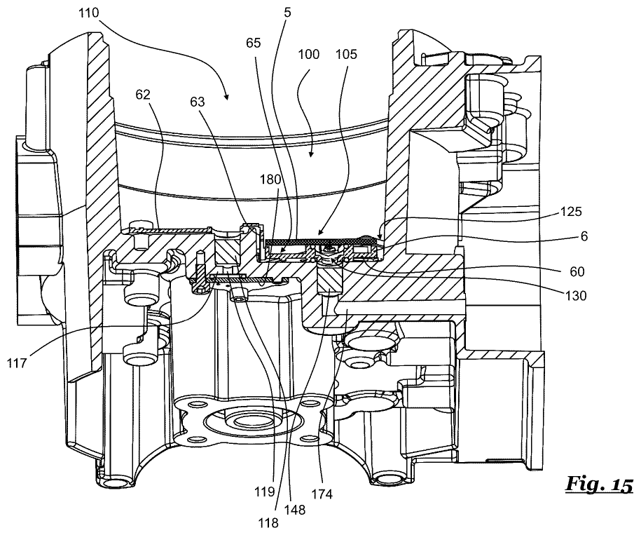

As illustrated, for example, in the embodiments of positioners 1 according to FIGS. 1, 2 or 15, the circuit board 5 can be fastened to the casing 11 by means of a support body 6. In the operational assembly state, the support body 6 is arranged between the circuit board 5 and the base 115 of the casing 11. The support body 6 has a support portion 60 which is inserted into the depression 105 together with the circuit board 5. A free space 125 is provided between the circuit board 5 and the circumferential wall 120 of the casing 11. A hollow space or a cavity 65 is formed in portions between the support body 6 and the circuit board 5.

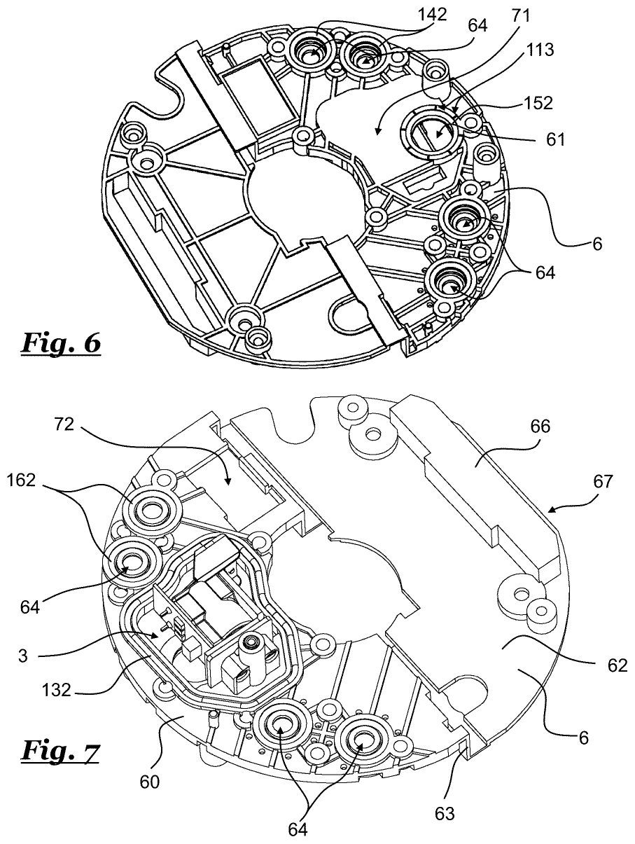

FIG. 6 shows an exemplary embodiment of a support body 6 with a substantially annular disk-shaped shape. The support body 6 can be subdivided into three regions, namely the support portion 60, a seat portion 62 offset with respect thereto, and a step 63 connecting the support portion 60 to the seat portion 62. The circuit board 5 is arranged in the region of the support portion 60. If a fixed connection of the circuit board 5 to the support body 6 is desired, a plurality of fastening means (not illustrated in detail), such as screws or clips, can be provided. The fastening means can be designed to prestress the circuit board 5 against the support body 6. The support body 6 is penetrated by a leadthrough 61 for the electropneumatic converter 3 and further leadthroughs 64 for the pneumatic sensors 4 (cf. FIG. 3). The leadthroughs 61, 64 are formed in the support portion 60.

The seat portion 62 can be formed at least in portions in a manner complementary in shape to the interior space 100 of the casing 10, in order to define an unambiguous position of the support plate 6 and of the circuit board 5 which is possibly preassembled thereon. For example, the seat portion 62 can be equipped with one or more projections 66 and/or recesses which are adapted in shape to the casing 11. Alternatively or additionally, the support plate 6 can have eccentric assembly aids 67 in order, for example in the case of a casing 11 of substantially cylindrical shape, to cooperate approximately with the inner side of a circumferential wall 120 and/or other wall portions.

FIGS. 2 and 3 show an embodiment of a positioner 1 in which the circuit board 5 is encapsulated with the aid of a potting 53. The potting 53 encases the majority of the circuit board 5. The upper side 51 of the circuit board 5 is completely covered by the potting 53 with the exception of the plug connector 55, as a result of which the electrical conductor tracks and electronics components arranged on the surface 51 of the circuit board 5 are insulated and protected from corrosive influences. The potting 53 can be implemented, for example, by an air-curing plastic, for example of polyurethane. It can be expedient that firstly the circuit board 5 is fastened to the support body 6 and then inserted together into the interior space 100 and subsequently coated with the potting 53. If the circuit board 5 is overpotted with potting material in the interior space 100 and encapsulated as a result, the cavity 65 and the free space 125 can be filled partially or even completely with the potting 53. The potting 53 can implement a form-fitting connection of the circuit board 5 to the casing 11. The potting 53 can form a sealing element which causes or at least contributes to the converter compartment 130 being separated fluidically, such as in a pressure-proof manner, from the electronics compartment 110.

In the operational assembly state of the positioner 1, at least one sealing element can be provided for pneumatic and/or pressure-proof separation of the electronics compartment 110 from the converter compartment 130. For this purpose, the at least one sealing element is expediently arranged between the circuit board 5 and the casing 11. Sealing elements can be implemented, for example, by sealing rings.

FIG. 6 shows the upper side 71 of a support body 6, where a sealing ring 152 is inserted into a receptacle surrounding the leadthrough 61. The further leadthroughs 64 are also equipped with a respective sealing ring 142 on the upper side 71 of the support body 6. In the operational installation state, in the region of the leadthroughs 61, 64, the support body 6 is in touch contact with the lower side 52 of the circuit board 5, for example according to FIGS. 2 and 3. In the operational installation state, the sealing rings 152, 142 seal between the support body 6 and the circuit board 5.

FIG. 7 shows the lower side 72 of the support body 6 which, in the operational installation state, is in touch contact with the base 115 of the casing 11 in the region of the leadthroughs 61, 64. The electropneumatic converter 3 covers the converter feedthrough for contacting the circuit board 5. Around the electropneumatic converter and the leadthrough 61 covered therewith, a sealing ring 132 is inserted into a sealing receptacle which is adapted in shape to the electropneumatic converter 3. On the further leadthroughs 64, annular sealing rings 162 are arranged in corresponding receptacles. In the operational installation state, the sealing rings 132, 162 seal between the support body 6 and the casing 11.

The cross-sectional view according to FIG. 2 extends through the electropneumatic converter 3 and the subregion of the converter compartment 130 which forms a receptacle 131 for the electropneumatic converter 3, which can be referred to as a converter receptacle 131. The cross-sectional view according to FIG. 3 extends through a pneumatic sensor 4 in the subregion of the converter compartment 130 which forms a further receptacle 41 for this pneumatic sensor 4, which can also be referred to as a sensor receptacle 141. Optionally, a pneumatic sensor 4 is arranged in the converter receptacle 131 (cf. FIG. 9).

The converter receptacle 131 illustrated in FIG. 2 forms a chamber which is separated from the electronics compartment 110 pneumatically and/or in a pressure-resistant manner. The receptacle 131 is partially delimited by a casing region 104 on the base 115 of the casing 11. Opposite the casing 11, the receptacle 131 is delimited by the circuit board 5. Between the circuit board 5 and the casing 11, the leadthrough 61 through the support body 6 delimits the converter receptacle 131. The potting 53 and the sealing elements, for example in the form of sealing rings 132, 162 (cf. FIGS. 6, 7) ensure reliable fluidic insulation of the converter receptacle 131 in the converter compartment 130 with respect to the electronics compartment 110 and also with respect to other receptacles 141 in the converter compartment 130.

The sensor receptacle 141 illustrated in FIG. 3 likewise forms a chamber which is separated from the electronics compartment 110 pneumatically and/or in a pressure-resistant manner. The sensor receptacle 141 is partially delimited by another casing region 106 on the base 115 of the casing 11. The sensor receptacle 141 is also delimited with respect to the casing 11 by the circuit board 5, and between the circuit board 5 and the casing 11 by the further leadthrough 64 of the support body 6. The sealing rings 142, 152 (cf. FIGS. 6, 7) on the further leadthrough 64 ensure, optionally together with the potting 53, fluidic insulation of the sensor receptacles 141 in the converter compartment 130 with respect to the electronics compartment 110 and expediently with respect to further receptacles (not illustrated in more detail) in the converter compartment 130. In order to detect at least one property, such as a pressure, a temperature or the like, of the pneumatic medium with the aid of the pneumatic sensor 4 at a measuring point (not illustrated in detail), a pneumatic line 174 extends away from the sensor receptacle 141 to a pneumatic compartment 170 described below. The pneumatic line 147 is covered over the full area in portions with a sinter filter 148 as an ignition lock.

A plurality of subregions of the positioner, for example the individual chambers which implement the converter receptacle 131 or the sensor receptacles 141, the electronics compartment 110 and/or the pneumatic compartment 170, may be designed and configured in a pressure-proof manner for mutual pressure differences between the subregions of at least 50 mbar, in particular at least 100 bar, preferably at least 1 bar, particularly preferably at least 1 bar, and/or not more than 10 bar, in particular not more than 5 bar, preferably not more than 2.5 bar.

Two pneumatic lines, namely a ventilation line 173 and an exhaust air duct 139, extend from the converter receptacle 131 to the pneumatic compartment 170, as shown for instance in FIG. 5. The ventilation line 173 or the supply air duct is designed and configured to connect the converter chamber 131 and the electropneumatic converter 3 arranged therein fluidically to a pneumatic source (not illustrated in detail).

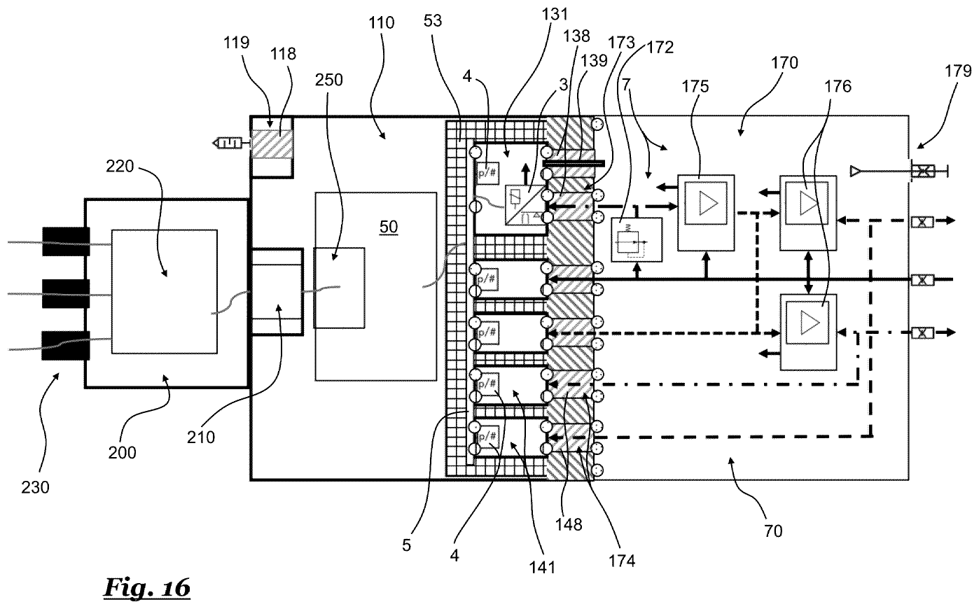

As illustrated in FIG. 13, the pneumatic lines 139, 173, 174 can extend, for example substantially in parallel, from the converter compartment 130 in the interior space 100 of the casing 11 through the casing wall thereof to the pneumatic compartment 170. The positioner 1 with pneumatic module 170 and pneumatic components 7 accommodated therein is illustrated schematically in FIG. 16. As can be seen in FIG. 2, the pneumatic compartment 170 can be formed by a side space of the casing 11. A pneumatic interface 171 is provided in the pneumatic compartment 170, where pneumatic components 7 or a pneumatic module comprising a plurality of pneumatic components 7 can be fastened (not illustrated in detail). The pneumatic interface 171 can be arranged, for example, on a casing portion 107 of the wall portion between converter compartment 130 and pneumatic compartment 170. The side space and the pneumatic module (not illustrated in more detail) can be matched to one another, for example, in such a way that the pneumatic module implements a shape-complementary insert for covering (e.g., completely covering) the side space.

The pneumatic module can be implemented, for example, as a component-uniform block, within which pneumatic ducts and a plurality of pneumatic components 7, for example pneumatic amplifiers, for instance a preamplifier 175 and main amplifier 176, flow restrictor and/or pressure reducer 172, are integrated. The exhaust air duct 139 can discharge a used pneumatic medium into the pneumatic compartment 170, which is connected to the surroundings or to a collection pipe for the insulated discharge of used pneumatic medium or exhaust gas from the positioner 1, so that the electronics components in the electronics compartment 110 do not come into contact with the pneumatic medium. The pneumatic sensors 4 can be connected by means of pneumatic lines 174 to different measuring points with respect to the different pneumatic components 7.

The electronics compartment 110 can expediently be insulated by the interior space 100 of the casing 11 being closed airtightly by a cover. In order to avoid an undesirable negative pressure in relation to the ambient pressure of the positioner 1 being able to form in the electronics compartment 110, a venting line 119 can penetrate an outer wall 117 of the casing 11. Depending on the intended use, the venting line 119 can be optionally closed or designed to be open to the surroundings by means of a cover part 180, 181.

The exemplary positioner 1 illustrated in FIG. 16 has a casing 11 which is equipped with a pressure-resistant “Ex d” cable leadthrough 210, by means of which the supply electronics 50 and other electronics components arranged in the electronics compartment 110 can be supplied and optionally actuated. For a particularly secure configuration, a Zener barrier 250 or the like can additionally be provided. Beyond the cable leadthrough 210, such as in a connection space 200 enclosed in a pressure-resistant manner, a connection circuit board 220 can be arranged. The connection circuit board 220 can be connected to external components, for example other components of a process plant, by means of at least one (here: three) pressure-resistant “Ex d” cable leadthroughs 230. FIG. 16 also shows a common venting 179 for exhaust air and for discharging pneumatic medium from the pneumatic compartment 170. For critical pneumatic media such as methane, the common venting can be connected to a collection pipe (not shown).

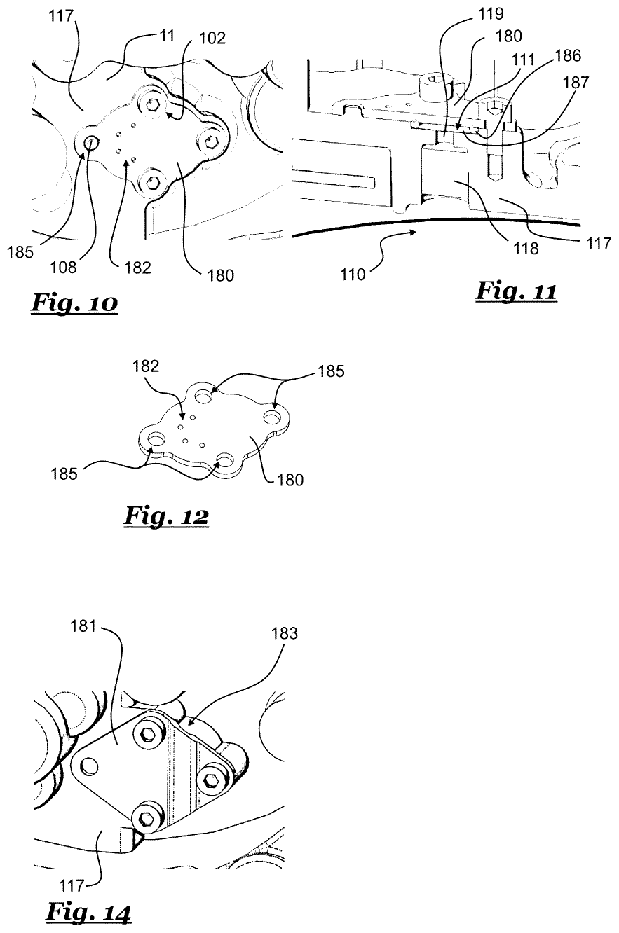

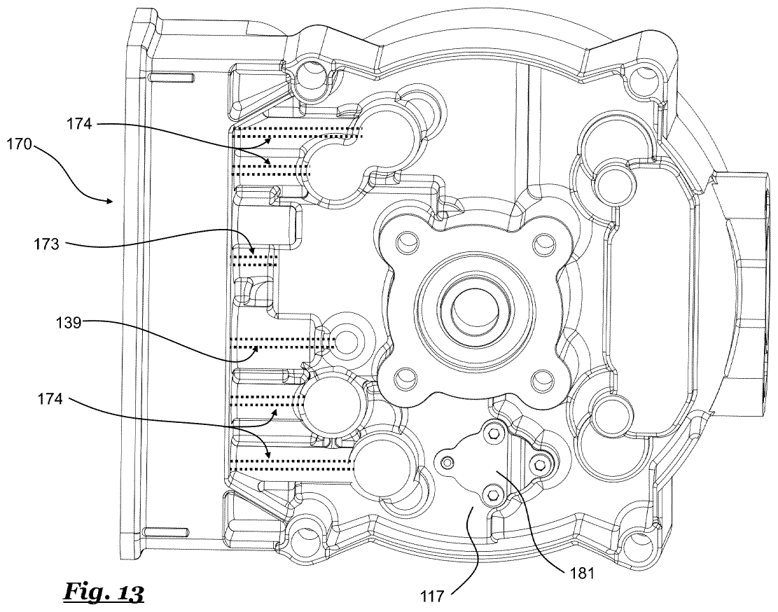

FIGS. 10-12 and 15 show a first variant of the cover part 180 which is penetrated by four passage openings 182. FIGS. 13 and 14 show another variant of the cover part 181 with a groove channel 183. The cover part 180, 181 can be equipped as an asymmetrical plate with one or more (here: four) assembly holes 185. For fastening to the casing 11, the latter can be embodied on its outer wall 117 with a protrusion 108 for fixing an assembly position for the cover part 180, 181, wherein this protrusion 108 is complementary in shape to the uniform assembly holes 185. The other assembly holes 185 can each be covered with a screw 102 for fastening the cover part 180, 181. For explosive environments, an ignition lock 118 can cover the venting line 119 over the full area. The muzzle 111 of the venting line 119 which can be covered with the cover part 180/181 is arranged on the outside of the outer wall 117. The cover part 180, 181 can be placed in front of the muzzle 111 in a first, open position, in which the venting line 119 communicates fluidically with the passage openings 182 or the groove channel 183, with the result that the electronics compartment 110 is connected to the surroundings. A membrane 187 can be arranged between the muzzle 111 and the cover part 180/181. The membrane 187 is operatively active only in the open position of the cover-part or-plate 180/181. The membrane 187 acts as a pressure compensation element. Configurations with a pressure compensation element designed differently from a membrane are also conceivable.

Alternatively, the cover part 180/181, as illustrated in FIG. 11, can be placed in front of the muzzle 111 in such a way that a section of the cover part 180/181 which is free of passage openings, groove ducts and the like covers the venting channel 119. A sealing element 186 surrounding the muzzle 111 in an annular manner is arranged between the cover part 180/181 and the outer wall 117. The membrane 187 can be implemented in one piece with the sealing element 186 as a pressure compensation element with an adhesively bonded round sealing ring (as a standard part). In the closed position of the cover part 180/181, the venting line 119 is closed with the aid of the sealing ring 186. In a state as illustrated in FIG. 11, in which the cover part 180/181 covers the muzzle 111 for closure of the electronics compartment 110, it is alternatively conceivable for the membrane 187 or a pressure compensation element to be omitted or not mounted.

The features disclosed in the above description, the figures and the claims can be of significance both individually and in any desired combination for the implementation of the disclosure in the different configurations.

### REFERENCE SYMBOLS

1 positioner
3 electropneumatic converter
4 pneumatic sensor
5 circuit board
6 support body
7 pneumatic component
11 casing
50 supply electronics
51 upper side/area (circuit board)
52 lower side/area (circuit board)
53 potting
55 plug connector
57 plug receptacle
60 support portion
61 leadthrough
62 seat portion
63 step
64 further leadthrough
65 cavity
66 protrusion
67 assembly aid
70 pneumatic module
71 upper side (supporting body)
72 lower side (supporting body)
100 interior space
102 screw
104 casing region
105 depression
106 another casing region
107 casing section
108 protrusion
109 fastening screw
110 electronics compartment
111 muzzle
113 ventilation duct
115 base
117 outer wall
118 sinter filter
119 venting line
120 circumferential wall
125 free space
130 converter compartment
131, 141 receptacle
132 sealing ring
138 sinter filter
139 exhaust air duct
142 sealing ring
148 sinter filter
152, 162 sealing ring
170 pneumatic compartment
171 pneumatic interface
172 pressure reducer
173, 174 pneumatic line
175 preamplifier
176 main amplifier
179 collection pipe
180,181 cover part
182 channel bore
183 groove channel
185 assembly hole
186 sealing element
187 membrane
200 connection space
210 cable leadthrough
220 connection circuit board
230 cable leadthrough
250 Zener barrier

1. A positioner for a pneumatic actuator for actuating a control instrument of a process plant, comprising:
an electropneumatic converter;
a circuit board including supply electronics for the electropneumatic converter; and
a casing including:
at least one electronics compartment configured to accommodate at least one electronic component of the positioner, and
a converter compartment configured to accommodate the electropneumatic converter, wherein the electronics compartment and the converter compartment are spatially separated from one another, the converter compartment being at least partially delimited by the circuit board.

2. The positioner according to claim 1, wherein the electropneumatic converter is arranged on a side of the circuit board which faces away from the electronics compartment.

3. The positioner according to claim 1, wherein the converter compartment is formed: by at least one receptacle which is arranged in a wall portion of the casing: and/or integrally with the casing, the receptacle being at least partially covered by the circuit board.

4. The positioner according to claim 3, wherein least one sealing element is arranged between the circuit board and the casing region surrounding the receptacle to separate the converter compartment, pneumatically and/or in a pressure-proof manner, from the electronics compartment.

5. The positioner according to claim 3, wherein the circuit board includes, in a region of the converter compartment, a surface coating configured to protect against pneumatic medium.

6. The positioner according to claim 1, wherein at least one pneumatic sensor is arranged in the converter compartment.

7. A positioner for a pneumatic actuator for actuating a control instrument of a process plant, comprising:
an electropneumatic converter;
a circuit board including supply electronics for the electropneumatic converter;
a casing including:
at least one electronics compartment configured to accommodate at least one electronic component of the positioner, and
a converter compartment configured to accommodate the electropneumatic converter, wherein the electronics compartment and the converter compartment are separated from one another, in that the converter compartment has including an exhaust air duct configured to discharge pneumatic medium from the electropneumatic converter to at least one collection pipe for exhaust air and/or into a pneumatic compartment in which at least one pneumatic component is accommodated.

8. The positioner according to claim 7, wherein an ignition lock, is arranged in or on the at least one exhaust air duct and/or the at least one collection pipe.

9. A positioner for a pneumatic actuator for actuating a control instrument of a process plant, comprising:
an electropneumatic converter;
a circuit board including supply electronics for the electropneumatic converter; and
a casing including at least one electronics compartment configured to accommodate at least one electronics component, and a converter compartment configured to accommodate the electropneumatic converter,
wherein the electronics compartment is spatially separated from the converter compartment and a pneumatic compartment in which at least one pneumatic component is accommodated.

10. The positioner according to claim 9, further comprising at least one pneumatic line that connects the converter compartment to the pneumatic compartment, wherein the at least one pneumatic line extends through the casing.

11. The positioner according to claim 10, wherein the casing comprises a casing portion which at least partially forms the pneumatic compartment and which comprises a pneumatic interface configured to connect the at least one pneumatic component, wherein the pneumatic interface is in fluidic connection with the converter compartment.

12. The positioner according to claim 1, wherein the supply electronics and/or the circuit board are/is encased by an encapsulation.

13. The positioner according to claim 12, wherein the encapsulation forms a pressure-proof pneumatic sealing element configured to separate the electronics compartment from the converter compartment.

14. The positioner according to claim 12, wherein the encapsulation is configured to seal the circuit board and/or the supply electronics with respect to the electronics compartment.

15. The positioner according to claim 1, wherein the electronics compartment comprises a venting line configured to compensate a pressure difference, with respect to surroundings of the positioner, the venting line being spaced from the converter compartment.

16. The positioner according to claim 15, wherein the venting line comprises a muzzle which is covered by a detachable cover part.

17. The positioner according to claim 15, further comprising an ignition lock arranged in the venting line.

18. The positioner according to claim 1, further comprising a ventilation duct that fluidically connects the electronics compartment to the converter compartment.

19. The positioner according to claim 18, wherein the ventilation duct comprises at least one opening in a sealing seat on the circuit board or the casing, and configured to receive a sealing element, the sealing seat not being covered by the sealing element.

20. The positioner according to claim 1, wherein the converter compartment comprises an exhaust air duct configured to discharge pneumatic medium from the electropneumatic converter to at least one collection pipe for exhaust air and/or into a pneumatic compartment in which at least one pneumatic component is accommodated.
